(19) United States
(12) Patent Application Publication
(10) Pub. No.: US 2014/0077998 A1
(43) Pub. Date: Mar. 20, 2014

(54) SUPPLEMENTAL LOCATION-RELATED INFORMATION TRANSMIT IN UNASSOCIATED WIRELESS STATES

(71) Applicants: Yuval Amizur, Kfar-Saba (IL); Leor Banin, Petach Tikva (IL); Uri Schatzberg, Kiryat Ono (IL)

(72) Inventors: Yuval Amizur, Kfar-Saba (IL); Leor Banin, Petach Tikva (IL); Uri Schatzberg, Kiryat Ono (IL)

(21) Appl. No.: 13/621,446

(22) Filed: Sep. 17, 2012

(51) Int. Cl. G01S 1/04

(52) U.S. Cl. CPC G01S 1/042
USPC 342/386

(57) ABSTRACT

Systems and methods are directed to information exchange between a location point (LP) and a wireless device. A LP may include a network access point (AP) and/or a dedicated location entity. In one embodiment, supplemental location-related information of a LP including, but not limited to, a geographic location source, geographic location accuracy, geographic location update time, LP type, distance from another LP, and/or timing offset calibration accuracy, may be wirelessly transmitted from a LP to a wireless device.

### TECHNICAL FIELD

This disclosure relates generally to the field of wireless communications, and in particular, to wireless device location identification.

### BACKGROUND ART

Given the advent of new applications and services directed to marketing opportunities and social networking, it has become increasingly important to accurately determine the location or position of wireless devices.

Various attempts have been made to develop indoor navigation systems that provide a digital electronic map to a wireless device upon entering a particular indoor area, e.g., a room, a shopping mall, etc. Typically, such indoor positioning systems have been based on Wi-Fi networks, using either received signal strength indicators (RSSIs) or timing-based techniques. However, these indoor positioning systems are not without accuracy and reliability issues, as they sometimes rely on certain assumptions that do not reflect real-world conditions or operational characteristics.

### BRIEF DESCRIPTION OF THE DRAWINGS

FIG. 1 depicts a functional block diagram of a wireless location identification system including a number of wireless devices coupled to a wired network via a location point, in accordance with various aspects and principles of the present disclosure.

FIG. 2 depicts a flow diagram illustrating a method of identifying location of wireless devices by supplying location-related information, in accordance with various aspects and principles of the present disclosure.

FIG. 3 depicts a flow diagram illustrating another method of identifying location of wireless devices by supplying location-related information, in accordance with various aspects and principles of the present disclosure.

FIG. 4 depicts a sequence flow diagram illustrating a further method of identifying location of wireless devices by supplying location-related information, in accordance with various aspects and principles of the present disclosure.

FIG. 5 depicts a functional block diagram of a wireless location identification system, in accordance with various aspects and principles of the present disclosure.

### DETAILED DESCRIPTION

In the description that follows, like components have been given the same reference numerals, regardless of whether they are shown in different embodiments. To illustrate an embodiment(s) of the present disclosure in a clear and concise manner, the drawings may not necessarily be to scale and certain features may be shown in somewhat schematic form. Features that are described and/or illustrated with respect to one embodiment may be used in the same way or in a similar way in one or more other embodiments and/or in combination with or instead of the features of the other embodiments.

In accordance with various embodiments of this disclosure, what is proposed is a wireless communication system and methods thereof for information exchange between a location point (LP) and a wireless device. For example, supplemental location-related information of a LP including, but not limited to, a geographic location source, geographic location accuracy, geographic location update time, LP type, distance from another LP, timing offset calibration accuracy, may be wirelessly transmitted from a LP to a wireless device.

For example, in one embodiment, a system is presented that includes at least one wireless device and a location point (LP) configured to wirelessly transmit data to the at least one wireless device. The transmitted data may at least include location specific information of the LP, which includes one or more of the following: geographic location source, geographic location accuracy, geographic location update time, LP type, distance from another LP, timing offset calibration accuracy.

In another embodiment, a system is presented that includes a wireless device configured to receive data from one or more location points (LPs). The data received by the wireless device at least includes location specific information of each LP of the one or more LPs.

In yet another embodiment, a method is presented that includes sending data from a location point (LP) to a wireless device. The data sent from the LP to the wireless device at least includes location specific information of the LP.

These and other features and characteristics, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of claims. As used in the specification and in the claims, the singular form of “a”, “an”, and “the” include plural referents unless the context clearly dictates otherwise.

By way of review, the inventors have observed that conventional wireless indoor navigation and location identification systems rely on certain assumptions that do not always hold true, thereby compromising reliability and accuracy. For example, some Wi-Fi-based techniques, especially those predicated on crowdsourcing/surveys, assume that network access points (APs) remain at a fix position. However, APs may be mounted on a vehicle (e.g., bus, train, etc.) or in a mobile apparatus, thereby severely impacting the efficacy of the associated location algorithm.

As another example, sometimes additional pseudo-AP devices are deployed to address certain coverage issues. These pseudo-AP devices are configured to act like a network AP for location purposes but intentionally lack full communication capabilities. However, without having any information as to whether a proximate pseudo-AP device is a fully functioning network AP or a pseudo device, wireless devices may attempt to associate and transfer/negotiate communication commands with the pseudo-AP device, thereby wasting power and bandwidth.

In yet another example, for wireless indoor location identification systems employing RSSI techniques, the associated location algorithm assumes that the network AP transmits its radio-frequency (RF) beacon at constant power. As a practical and/or implementation-specific matter, beacons do not always operate at constant energy.

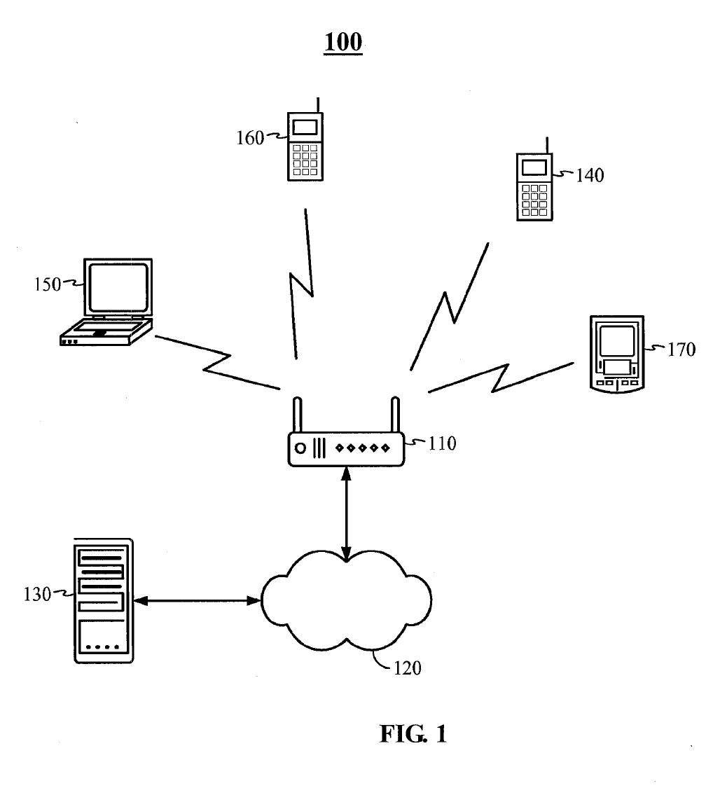

With this said, the disclosed embodiments are directed to a wireless location identification system and method that is capable of exchanging certain supplemental location-related information that addresses many of the deficiencies noted above. In particular, FIG. 1 depicts a non-limiting example of a wireless location identification system 100, in accordance with various aspects and principles of the present disclosure. System 100 includes a network location point (AP) 110 in communication with a number of wireless devices, including wireless telephones 140 and 160, notebook computer 150, and personal digital assistant 170. LP 110 is configured to provide the wireless devices 140, 150, 160, 170 access to network 120. As will be appreciated, network 120 is communicatively coupled, either wirelessly or wired, to server 130 that may comprise one or more computing platforms.

As used herein, the term “wireless device(s)” refers to any device that may communicate with other devices via wireless signals. Such devices may comprise, for example, a laptop, mobile device, cellular/smartphone, gaming device, tablet computer, a wireless-enabled patient monitoring device, personal communication system (PCS) device, personal digital assistant (PDA), personal audio device (PAD), portable navigational device, and/or any other electronic wireless-enabled device configured to receive a wireless signal. It may also include relatively stationary devices such as desktop computers with wireless capabilities. Such wireless devices may communicate via any number of wireless communication protocols, examples of which are noted below.

As used herein, the term “location point” or “LP” refers to a device with location determining capabilities. Such devices may include a network access point (AP) and/or a dedicated location entity.

As used herein, the term “access point” or “network access point” refers to any device with the ability to receive wireless signals from one or more devices and provides access to a network, such as a local area network (LAN) or the Internet, for example. It should be appreciated that such devices also include location determining operations. In embodiments, a network AP may be installed at a fixed terrestrial location or may be installed on a vehicle or mobile apparatus. In one aspect, a network AP may include a femtocell utilized to extend cellular telephone service into a business or home. In such an implementation, one or more wireless devices may communicate with the femtocell via a code division multiple access (CDMA) cellular communication protocol, for example, and the femtocell would provide the wireless devices access to a larger cellular telecommunication network by way of another broadband network such as the Internet. Of course, these are example implementations utilizing one or more wireless devices and a network AP, and the scope of claimed subject matter is not limited in this respect.

As used herein, a dedicated location entity may be a degraded AP, as compared with a network AP, with only location determining capabilities and lacking network access and/or connectivity. As used herein, a dedicated location entity or a degraded AP may include a Pseudo AP, and/or a dedicated ToF tag AP.

As used herein, the term “network” refers to a wireless communication network that may be utilized in example implementations as discussed below. The network may be configured to operate under a variety of wireless communication protocols and standards, such as, for example, Wi-Fi, WiMax, WWAN, WLAN, WPAN, Bluetooth, GSM, CDMA, GPRS, 3G or 4G, LTE, Wireless USB, IEEE 802.11x standard, IEEE std. 802.11k-2008 published Jun. 12, 2008, or IEEE std. 802.11-2012 published Mar. 29, 2012, or any other implementation of a suitable wireless standard. It will be appreciated that the wireless communication is not limited to any specific standard and the examples discussed may be implemented separately or in combination with each other.

Referring to FIG. 1, wireless location identification system 100 is configured to facilitate transmit of supplemental location-related information between LP 110 and wireless devices 140, 150, 160, 170, in accordance with various aspects and principles of the present disclosure. This supplemental information enables the accurate location/position determination of wireless devices 140, 150, 160, 170 and may be conveyed during the initial, unassociated communication stages (e.g., acknowledgement, hand-shaking, negotiation phases, etc.) between wireless devices 140, 150, 160, 170 and LP 110—without having to establish full network connectivity.

That is, wireless standards/protocols define the contents and field formats of certain packet frames that contain basic information regarding the communicating entities, such as, LP 110 and wireless devices 140, 150, 160, 170. For example, IEEE 802.11-2012 and/or IEEE 802.11k-2008 define the packet frame formats for WiFi communications. Such framing formats may be exploited to introduce supplemental location-related information that can be transmitted between the entities in order to optimize the determination of entity location/position.

Consistent with various embodiments, the supplemental location-related information may be configured to include, for example, geographic location source data indicative of which type of source the LP obtains its geographic location; geographic location accuracy data indicative of how accurate the obtained geographic location is; and geographic location update timing data indicative of the last time the geographic location was updated.

In addition, the supplemental location-related information may include LP type data, such as, for example, data indicating whether the LP is stationary or mobile, whether the LP is a pseudo AP or not, whether the LP is a dedicated time-of-flight (ToF) tag AP or not, and/or whether the LP is a WiFi AP or WiFi non-AP (e.g., a client); distance data indicative how far the LP is from other APs; timing offset calibration accuracy data, which is set to zero when the LP is not calibrated, or combinations thereof.

In various embodiments, the geographic location source can be manually configured, automatically deduced from other APs within a certain precision, provided by a network server, etc. In certain embodiments, the pseudo-AP may be configured to provide lower radiated RF power, smaller coverage, and deployed for only location determination purposes.

Returning to FIG. 1, the supplemental location-related information may be broadcasted simultaneously to numerous wireless devices 140, 150, 160, 170 by employing the RF beacon of LP 110, in accordance with various aspects and principles of the present disclosure. That is, in certain wireless implementations, such as, for example, a WiFi network, LP 110 alerts wireless devices 140, 150, 160, 170 that are within range as to its existence, by broadcasting an RF beacon signal containing a beacon frame. As such, the RF beacon signal identifies and announces LP 110 along with supplying AP-related information, as contained in the beacon frame. LP 110 (or pseudo-APs) may transmit the beacon signal on the order of milliseconds. Such broadcasting occurs in an unassociated WiFi state in which wireless devices 140, 150, 160, 170 have not established network connectivity through LP 110. Given the capability to transmit AP-related information 110 in an unassociated state, supplemental location-related information may be introduced in the beacon frame.

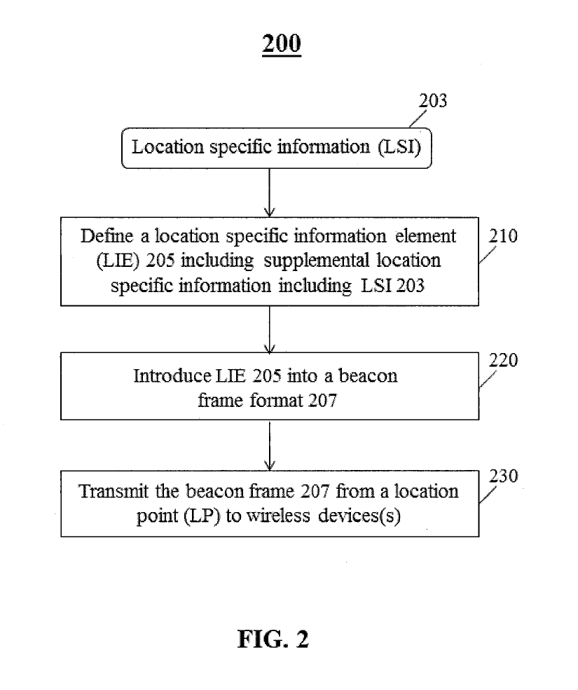

To this end, FIG. 2 depicts flow diagram of process 200 that supplies supplemental location-related information via broadcasting beacon frames, in accordance with various aspects and principles of the present disclosure. It is, once again noted, that although the disclosed embodiments are herein described relative to WiFi implementation and compatible with one or more IEEE 802.11x standards for the sake of clarity and tractability, the scope of claimed subject matter is not limited in this regard.

In process 200, location specific information 203 of LP 110 may be defined in location specific information element (LIE) 205.

As noted above, standard information, such as, for example, geographic location of LP 110, may be included in LIE 205. However, LIE 205 may be defined to include supplemental location-related information, such as location specific information 203. In various embodiments, LIE 205 may use one of the reserved WiFi format frame element IDs (e.g., IDs 128-129, 133-136, 143-173, 175-220, and 222-255) as shown in Table 8-54 at IEEE 802.11-2012 or the reserved element IDs as listed in Table 7-26 at IEEE 802.11k-2008. For example, the location specific IE 205 may be defined as element 175 in Table 8-54 at IEEE 802.11-2012.

By way of illustration, LIE 205 may be configured to include supplemental location-related data as shown in following Table 1.

As depicted in Table 1, LIE 205 may include location specific information 203 indicative of AP-type information, such as, whether LP 110 is stationary or mobile, or whether it is a pseudo AP or not; geographic location source, geographic location accuracy, geographic location update time, distance from another AP; and/or timing offset calibration accuracy. The location specific information 203 may occupy a number of octets as may be suitable for implementation purposes. For complete description of LIE 205, Table 1 also includes standard information such as geographic location information having octet framing similar to the measurement report field format for the location configuration information report, as provided by IEEE 802.11k-2008, section 7.3.2.22.9 or IEEE 802.11-2012, section 8.4.2.24.10.

TABLE 1

| Octet | Bit | Information |
|---|---|---|
| 1 | 0 | Mobile/Not Mobile 1/0 |
| 1 | 1 | Dedicated location entity (e.g., |
| | | Pseudo AP) - 1 otherwise 0 |
| Similar to Measurement | | Geographic location |
| Report field format | | |
| for Location Configuration | | |
| Information Report | | |
| See section 7.3.2.22.9 at IEEE | | |
| 802.11k-2008 or section | | |
| 8.4.2.24.10 at IEEE | | |
| 802.11-2012 | | |
| | | Geographic location source |
| | | Geographic location accuracy |
| | | Geographic location update |
| | | time |
| | | Distance from another AP |
| | | Timing offset calibration |
| | | accuracy |

Referring back to process 200, at block 220, LIE 205 defined at block 210 may be introduced into a beacon frame format 207. Generally, beacon frame includes a MAC header, a beacon frame body, and a frame check sequence (FCS), as known to one of ordinary skill in the art. For example, the beacon frame body of Table 8-20 at IEEE 802.11-2012 includes mesh channel switch parameter information and vendor specific information. In the example shown in Table 2, beacon frame body 207 includes information of LIE 205.

At block 230 of process 200, the beacon frame is broadcasted from LP 210 to wireless devices 140, 150, 160, 170. The beacon frame body includes LIE 205 which contains supplemental location specific information 203 indicative of AP-type information, such as, whether LP 110 is stationary or mobile, or whether it is a pseudo AP or not; geographic location source, geographic location accuracy, geographic location update time, distance from another AP; and/or timing offset calibration accuracy. In this manner, supplemental location-related information may be broadcasted to numerous wireless devices 140, 150, 160, 170 by virtue of broadcast RF beacon of LP 110 without requiring an association or connection to a network.

TABLE 2

| Information | Notes |
|---|---|
| Mesh Channel Switch | |
| Parameters | |
| Location Specific | The Beacon Location information element is |
| information Element 205 | optionally present if |
| | dot11MgmtOptionLocationActivated is true |
| Vendor Specific | One or more vendor-specific elements are |
| | optionally present. These elements follow all |
| | other elements. |

In certain embodiments, the supplemental location-related information may be provided to wireless devices 140, 150, 160, 170 by employing the Location Configuration Information (LCI) Report as defined by IEEE 802.11x standard. In particular, wireless devices 140, 150, 160, 170 in the vicinity of the LP 110 may initiate an inquiry to LP 110 requesting its current position. In response, LP 110 transmits an LCI Report, which typically includes standard current position Information, such as, for example, latitude data, longitude data, altitude data, and optionally azimuthal data.

Given this preliminary reporting scheme, supplemental location-related information may be adapted and introduced into the LCI report format to transmit or convey the supplemental location-related information to inquiring devices 140, 150, 160, 170 in an unassociated state manner.

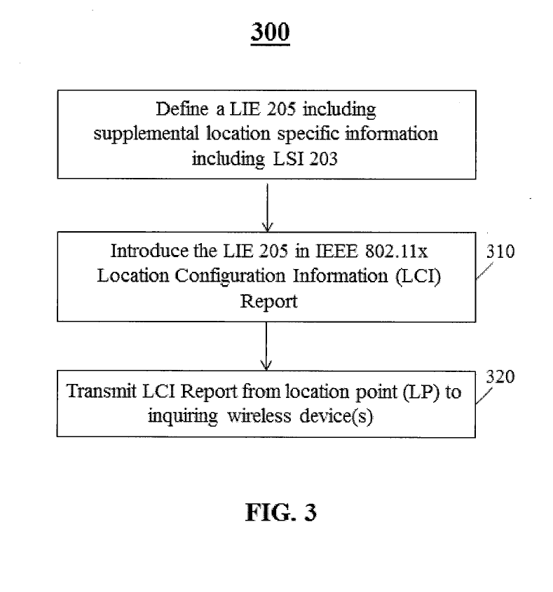

FIG. 3 depicts flow diagram of process 300 that supplies supplemental location-related information via the LCI report, in accordance with various aspects and principles of the present disclosure. At block 310 of process 300, location specific information element (LIE) 205 including at least the location specific information 203 as defined above can be introduced into the LCI Report in a manner consistent with IEEE 802.11k-2008 or IEEE 802.11-2012 standards.

At block 320 of process 300, the LCI report including location specific information element (LIE) 205 may be transmitted to inquiring wireless device(s) 140, 150, 160, 170, in accordance with IEEE 802.11k-2008 or IEEE 802.11-2012 standards.

In certain embodiments, the supplemental location-related information may be provided to wireless devices 140, 150, 160, 170 by exploiting the time-of-flight (ToF) measurement protocol. That is, the supplemental location-related information may be provided in response to ToF measurement requests.

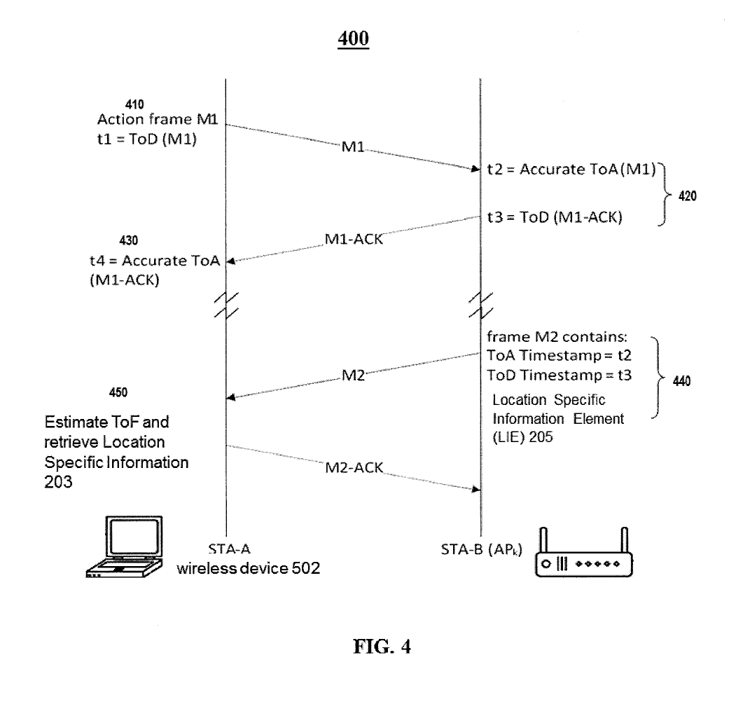

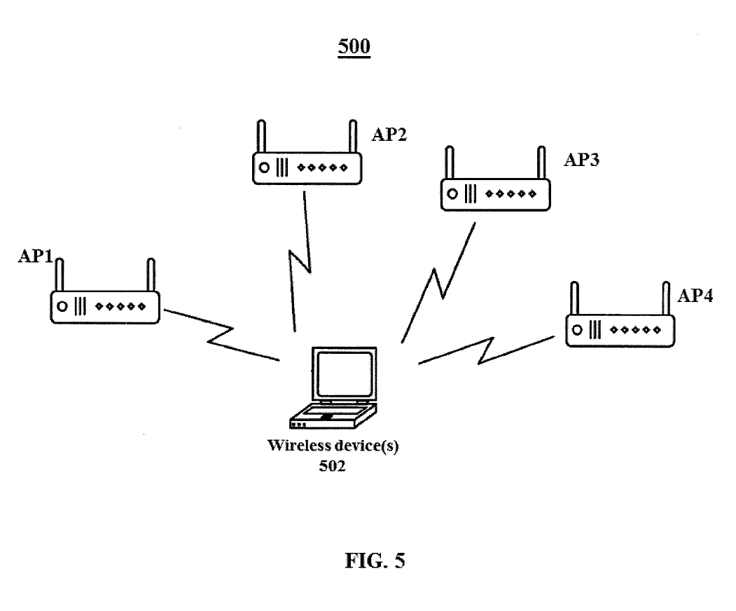

As such, FIG. 4 depicts sequence flow diagram 400 illustrating a ToF technique for supplying supplemental location-related information and FIG. 5 depicts a functional block diagram of a corresponding wireless location system 500 configured to perform ToF measurements, in accordance with various aspects and principles of the present disclosure.

As shown in FIG. 5, system 500 comprises multiple network APs, e.g., AP1, AP2, AP3, AP4, etc., and wireless device 502 at an unknown position. APs 1-4 may be devices that allow for wireless devices to communicate with each other by acting as both a transmitter and receiver of WLAN radio signals. APs 1-4 may take the form of LP 110 discussed above, including dedicated hardware devices that include a built-in network adapter, antenna, radio transmitter, etc. while wireless device 502 may take the form of any one of wireless devices 140, 150, 160, 170. In one embodiment, system 500 incorporates at least three APs (although FIG. 5 depicts AP1 through AP4 for illustration purpose), that receive wireless signals from an unknown location.

Referring to FIG. 4, at interval 410, wireless device 502 may initially transmit an action frame M1 (e.g., request message) to LP and record timestamp T1 indicating the time instant that the message is transmitted (e.g., time of departure (ToD) of M1).

At interval 420, the LP may receive action frame Ml, record the time instant it receives message M1 as T2 (i.e., time of arrival (ToA) of M1) and, at a later time, transmits an acknowledgement message M1-ACK back to wireless device 502 and records M1-ACK's ToD as T3.

At interval 430, wireless device 502 may receive the acknowledgement message M1-ACK and record the time instant it receives the message M1-ACK as T4 (i.e., ToA of M1-ACK).

At interval 440, the LP may send frame M2, in response to the action frame Ml, to wireless device 502. The frame M2 may contain the time T2, which is the time instant the LP received message M1, i.e., ToA of Ml, the time T3 that represents the time instant the LP sends the acknowledgement message M1-ACK, i.e., ToD of M1-ACK, and may accommodate other information. That is, information can be piggybacked onto or otherwise coupled to the ToF response frame (or message) M2. The piggybacked information can then be transmitd between the LP and wireless device 502. In certain embodiments, supplemental location-related information may be introduced via response frame M2. For example, location specific information element (LIE) 205 may be piggybacked onto response frame M2.

With this in mind, at interval 450, wireless device 502 may receive response frame M2, which may at least include location specific information element (LIE) 205. Wireless device 502 may then possesses T1 and T4 information, which have been recorded at intervals 410 and 430, respectively, T2, T3 information, as well as piggybacked location specific information element (LIE) 205, which has been retrieved from response frame M2 at interval 440.

The time-of-flight (ToF) between wireless device 502 and the LP can then be calculated using the following equation:

ToF=[(T4−T1)−(T3−T2)]/2

The distance between wireless device 502 and the LP can then be calculated according to rₖ=ToF*C, wherein C is the speed of light, wherein k=1, 2, . . . k, and K is greater than 3 for trilateration (e.g., k=4 in the example of FIG. 5).

Meanwhile, wireless device 502 may retrieve the piggybacked location specific information element (LIE) 205 from response frame M2, which is a response to the action frame M1. In addition, at a later time, wireless device 502 may send acknowledge frame M2-ACK to LP according to the ToF measurement protocol. In so doing, supplemental location-related information may be supplied by piggybacking location specific information element (LIE) 205 on the ToF protocol in an unassociated state manner.

Having thus described the basic concepts, it will be rather apparent to those skilled in the art after reading this detailed disclosure that the foregoing detailed disclosure is intended to be presented by way of example only and is not limiting. Various alterations, improvements, and modifications will occur and are intended to those skilled in the art, though not expressly stated herein. These alterations, improvements, and modifications are intended to be suggested by this disclosure, and are within the spirit and scope of the exemplary aspects of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure. In addition, the term “logic” is representative of hardware, firmware, software (or any combination thereof) to perform one or more functions. For instance, examples of “hardware” include, but are not limited to, an integrated circuit, a finite state machine, or even combinatorial logic. The integrated circuit may take the form of a processor such as a microprocessor, an application specific integrated circuit, a digital signal processor, a micro-controller, or the like.

Furthermore, the recited order of processing elements or sequences, or the use of numbers, letters, or other designations therefore, is not intended to limit the claimed processes and methods to any order except as can be specified in the claims. Although the above disclosure discusses through various examples what is currently considered to be a variety of useful aspects of the disclosure, it is to be understood that such detail is solely for that purpose, and that the appended claims are not limited to the disclosed aspects, but, on the contrary, are intended to cover modifications and equivalent arrangements that are within the spirit and scope of the disclosed aspects.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed subject matter requires more features than are expressly recited in each claim. Rather, as the following claims reflect, inventive aspects lie in less than all features of a single foregoing disclosed embodiment. Thus, the claims following the detailed description are hereby expressly incorporated into this detailed description.

What is claimed is:

1. A system comprising:
at least one wireless device; and
a location point (LP) configured to wirelessly transmit data to the at least one wireless device,
wherein the transmitted data comprises location specific information of the LP, the LP location specific information comprising one or more of the following: geographic location source, geographic location accuracy, geographic location update time, LP type, distance from another LP, timing offset calibration accuracy, and a combination thereof.

2. The system of claim 1, wherein the LP comprises a network access point (AP), a dedicated location entity, and a combination thereof.

3. The system of claim 1, wherein the LP comprises a dedicated location entity comprising a pseudo-AP, a dedicated ToF tag AP, and a combination thereof.

4. The system of claim 1, wherein the LP is configured to transmit the data with the at least one wireless device in an un-associated wireless state.

5. The system of claim 1, wherein the LP type indicates whether the LP is stationary or mobile, whether the LP is a pseudo AP or not, whether the LP is a dedicated time-of-flight (ToF) tag AP or not, whether the LP is a wireless AP or a wireless non-AP, or a combination thereof.

6. The system of claim 1, wherein the LP is configured to transmit the data via a broadcast.

7. The system of claim 1, wherein the LP is configured to transmit the data via an RF beacon signal, the RF beacon signal including a location specific information element.

8. The system of claim 7, wherein the location specific information element comprises the LP location specific information.

9. The system of claim 8, wherein the location specific information element further comprises standard information comprising geographic location of the LP.

10. The system of claim 1, wherein the LP is configured to transmit the data in a location configuration information (LCI) report, the location configuration information (LCI) report comprising the LP location specific information.

11. The system of claim 1, wherein the LP is configured to send the data in a response to a time-of-flight (ToF) request, wherein the response comprises the LP location specific information.

12. A system comprising:
a wireless device configured to receive data from one or more location points (LPs),
wherein the data received by the wireless device at least comprises location specific information of each LP of the one or more LPs, the LP location specific information comprising one or more of the following: geographic location source, geographic location accuracy, geographic location update time, LP type, distance from another LP, timing offset calibration accuracy, and a combination thereof.

13. The system of claim 12, wherein the one or more LPs comprise a network access point (AP), a dedicated location entity, and a combination thereof.

14. The system of claim 12, wherein the wireless device is configured to receive the data from the one or more LPs in an un-associated wireless state.

15. The system of claim 12, wherein the wireless device is configured to receive the data via a RF beacon signal, the RF beacon signal comprising a location specific information element.

16. The system of claim 15, wherein the location specific information element comprises the LP location specific information.

17. The system of claim 16, wherein the location specific information element further comprises standard information including geographic location.

18. The system of claim 12, wherein the wireless device is configured to receive the data in a location configuration information (LCI) report, the location configuration information (LCI) report comprising the LP location specific information.

19. The system of claim 12, wherein the wireless device is configured to receive the data in a time-of-flight (ToF) response to a ToF request message, wherein the ToF response comprises the LP location specific information.

20. The system of claim 12, wherein the wireless device is configured to calculate time-of-flight (ToF) between the wireless device and the each of the one or more LPs and to estimate a position of the wireless device using the location specific information.

21. A method comprising:
sending data from a location point (LP) to a wireless device,
wherein the data sent from the LP to the wireless device comprises location specific information of the LP, the LP location specific information comprising geographic location source, geographic location accuracy, geographic location update time, LP type, distance from another LP, timing offset calibration accuracy, and a combination thereof.

22. The method of claim 21, wherein the sending of the data from the LP to the wireless device is in an un-associated wireless state.

23. The method of claim 21, wherein the geographic location source of the LP is manually configured, or automatically deduced from other LPs in a neighborhood or from a server.

24. The method of claim 21, wherein the sending of the data further comprises:
introducing into a RF beacon signal a location specific information element, the location specific information element comprising the LP location specific information; and
transmitting the RE beacon signal from the LP to the wireless device.

25. The method of claim 21, wherein the sending of the data from the LP to the wireless device further comprises:
introducing the LP location specific information, in a location specific information element, into a Location Configuration Information (LCI) Report; and
transmitting the LCI report from the LP to the wireless device.

26. The method of claim 21, wherein the sending of the data from the LP to the wireless device further comprises:
introducing the LP location specific information, in a location specific information element, into a time-of-flight (ToF) response in response to a ToF request; and
transmitting the ToF response comprising the LP location specific information from the LP to the wireless device.

27. The method of claim 26, wherein the ToF response further comprises time-of-arrival (ToA) timestamp of the ToF request and time-of-departure (ToD) timestamp of a ToF acknowledgement message.

28. The method of claim 26, further comprising calculating the time-of-flight (ToF) between the wireless device and the AP, and estimating a position of the wireless device using the LP location specific information.
